(19) United States
(12) Patent Application Publication
(10) Pub. No.: US 2026/0281986 A1
(43) Pub. Date: Sep. 17, 2026

(54) Method for communicating control information

(71) Applicant: ORANGE, Issy-les-Moulineaux (FR)

(72) Inventors: Joe SAAD, CHATILLON (FR); Mohamad YASSIN, CHATILLON (FR); Salvatore COSTANZO, CHATILLON (FR)

(21) Appl. No.: 19/471,737

(22) PCT Filed: Apr. 3, 2024
(86) PCT No.: PCT/EP2024/059046

§ 371 Date: Oct. 2, 2025

(30) Foreign Application Priority Data
Apr. 6, 2023 (FR) FR2303470

(51) Int. Cl. H04W 72/0446; H04W 72/232

(52) U.S. Cl. CPC H04W 72/0446; H04W 72/232

(57) ABSTRACT

A communication method that includes transmitting in a first transmission interval control information including a first indicator of a bandwidth part for transmitting data associated with a first slice via the first bandwidth part, a second indicator of a bandwidth part for transmitting or receiving, via this second bandwidth part, data associated with a second slice, and a first switching time indicator for switching active bandwidth part between the first bandwidth part and the second bandwidth part.

### FIELD OF THE INVENTION

The present invention relates to the field of digital communications. Within this field, the invention more particularly relates to the use of control information within a telecommunication system.

The invention especially, but not exclusively, applies to transmission of control information in a mobile network, for example a mobile network of fifth or later generation, such as specified by 3GPP and/or O-RAN.

### PRIOR ART

So-called 5G networks have significant evolutions with respect to the previous generation, called 4G.

Among these evolutions network slicing is worthy of note. This slicing was introduced to meet the requirements of services that 5G networks must provide. These services include URLLC (Ultra Reliable and Low Latency Communication) services, eMBB (enhanced Mobile BroadBand) services, mMTC (massive Machine Type Communication) services, V2X (Vehicle to everything) services and HMTC (High Performance MTC) services. Slicing allows the network to be partitioned into logical slices that are isolated from one another. Each slice is dedicated to one service and benefits from radio resources. A slice is identified by its identifier, i.e. its S-NSSAI (Single Network Slice Selection Assistance Information). A UE (User Equipment) may be associated with eight slices simultaneously. The user equipment connected to the network transmits the S-NSSAI identifier of the slice/service to which it wishes to access. As regards the evolution of numerology, multiple SCSs (SubCarrier Spacings) have been introduced as indicated in [Table 1], which is based on Table 4.2-1 of the specification TS38.211 v15.10.0.

TABLE 1

| μ | 0 | 1 | 2 | 3 | 4 |
|---|---|---|---|---|---|
| SCS (kHz) | 15 | 30 | 60 | 120 | 240 |
| Δf = 2^{μ} × 15[kHz] | | | | | |
| OFDM | 71.35 | 35.68 | 17.84 | 8.92 | 4.46 |
| Symbol duration (μs) | | | | | |
| TTI | 1 | 0.5 | 0.25 | 0.125 | 0.0625 |
| Duration (ms) | | | | | |

The SCS (SubCarrier Spacing) is flexible. Increasing numerology, i.e. SCS, reduces the duration of the OFDM symbol and the TTI (Transmission Time Interval), and therefore reduces latency for services that are very demanding in terms of delay.

Transmission between a transmitter and a receiver is organized into frames that each contain subframes of a duration dependent on the numerology, 10 subframes of 1 ms each for example. The number of slots per subframe is dependent on numerology, on the choice u of SCS, and each slot contains a number

$${N}_{symb}^{slot}$$

of consecutive OFDM symbols, as indicated in section 4.3.2 of TS 38.211 v17.4.0.

Concomitantly with the evolution of numerology, the notion of BWP (BandWidth Part) was introduced to allow various numerologies to be implemented. A BWP is a set of contiguous PRBs (Physical Resource Blocks) associated with a numerology. A PRB (Physical Resource Block) is the smallest radio resource that can be allocated to a UE. The UE scans the radio resources allocated to it in a BWP to receive the data intended for it in the DL (DownLink) direction. The network can configure the UE with four BWPs in the downlink direction and likewise in the UL (UpLink) direction, but only one BWP is active at a given time in the DL direction and only one in the UL direction.

When the UE requires a new service, for example on switching from an eMBB service to a URLLC service, the active BWP is not necessarily the best suited to the URLLC service. Another bandwidth part may then be switched to, typically a bandwidth part associated with a higher numerology so as to reduce the delay for this URLLC service. The BWP switching mechanism ensures that the active BWP is the one best suited to the requirements of the current service.

The quickest way of switching among several possibilities is switching based on DCI (Downlink Control Information) (DCI-based BWP switching).

The DCI may have a number of formats, from the format 0_0 to the format 4_2 as indicated in [Table 2], which is based on Table 7.3.1-1 of the specification TS 38.212 v17.4.0, which formats are associated with various schedules for the downlink direction or the uplink direction.

TABLE 2

| DCI format | Usage |
|---|---|
| Format 0_0 | PUSCH scheduling with reduced overhead |
| Format 0_1 | PUSCH scheduling |
| Format 0_2 | PUSCH scheduling with reduced overhead |
| Format 1_0 | PDSCH scheduling with reduced overhead |
| Format 1_1 | PDSCH scheduling |
| Format 1_2 | PDSCH scheduling with reduced overhead |
| . . . | |
| Format 4_2 | PDSCH scheduling |

The DCI is transmitted in a PDCCH (Physical Downlink Control Channel) and the user equipment receives it as recurrently as the data intended for it.

The DCI includes a lot of control information. In formats 0_1 and 1_1, which are respectively associated with uplink and downlink scheduling without reduced overhead (non-reduced overhead format), to dynamically allocate time and frequency resources to the data channel (PDSCH or PUSCH) the DCI comprises, among other information: MCS (Modulation and Coding Scheme), BWP indicator, frequency-domain resource assignment, time-domain resource assignment (K0/K2), etc., and furthermore, for the format 1_1: feedback timing indicator PDSCH-to-HARQ-ACK (K1).

Once decoded, the DCI in particular provides the user equipment with the time- and frequency-domain location of the radio resources to be scanned.

The field “time-domain resource assignment” allows the UE to determine the value of K0 for DCI format 1_1, in accordance with sections 5.1.2.1 and 5.1.2.1.1 of the specification TS38.214 v15.16.0, and to determine the value of K2 for DCI format 0_1, in accordance with sections 6.1.2.1 and 6.1.2.1.1 of the specification TS38.214 v15.16.0.

The field “feedback timing indicator PDSCH-to-HARQ-ACK” of DCI format 1_1 allows the UE to determine the value of K1, in accordance with section 9.2.3 and Table 9.2.3-1 of the specification TS38.213 v15.15.0.

K0 gives the offset in number of slots between reception of the DCI and the downlink radio resources scheduled for transmission, via the data channel, PDSCH, of the data intended for the UE.

K1 gives the offset in number of slots between when the radio resources are scheduled for the downlink (PDSCH) and when the ACK/NACK must be transmitted by the same UE.

Thus, if the format of the DCI is 1_1, the user equipment determines that the data intended for it transmitted in the PDSCH are scheduled for K0 slots after reception of the DCI, and that it must transmit in the PUSCH an ACK/NACK K1 slots after reception of the DCI.

K2 gives the offset in number of slots between the reception of the DCI, and the radio resources scheduled for the PUSCH uplink.

Thus, if the DCI format is 0_1, the user equipment determines that the data that it must transmit in the uplink channel, PUSCH, is scheduled for K2 slots after reception of the DCI.

In the example illustrated in FIG. 1, the control channel (PDCCH), which comprises the DCI, corresponding to the format 1_1, is received in slot 0. K0 gives the offset in number of slots, three in the example, to use to determine the slot, number three in the example, that contains the data channel (PDSCH) with the data intended for the user equipment. K1 gives the offset in number of slots, five in the illustration, with respect to the slot containing the data, defining the slot, number 8 in the example, in which the user equipment must acknowledge reception, ACK/NACK, of the data transported in slot number three.

In the example illustrated in FIG. 2, the control channel (PDCCH), which comprises the DCI, corresponding to the format 0_1, is received in slot 0. K2 gives the offset in number of slots, three in the example, from reception of the DCI for the user equipment to schedule the data that it has to transmit over the uplink channel (PUSCH), to slot 3 in the example.

The “frequency-domain resource assignment” field of the DCI allows the UE to identify the resource blocks that have been allocated to it in the bandwidth part identified by the BWP indicator for transmission of the data intended for it.

When the user equipment decodes the received DCI, the BWP indicator tells it which BWP should be activated. If this BWP indicator has changed, the user equipment must switch between bandwidth parts within a certain time, in accordance with the DCI-based BWP switching mechanism since the DCI determines the BWP to scan.

The switching delay between BWPs is indicated in [Table 3], which is based on Table 8.6.2-1 of the specification TS38.133 v15.20.0.

TABLE 3

| | |
|---|---|
| NR slot | BWP switching delay |
| length | T_{BWPswitchdelay} (slots) |

| μ | (ms) | Type 1 | Type 2 |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

A UE connected to the network and associated with a plurality of slices receives data relating to these various slices. In a known manner, the UE scans the same bandwidth part for these various services to receive its data. This mechanism is sub-optimal when the services have very different requirements, for example a low latency and high reliability for a URLLC service and high data rate for an eMBB service. Specifically, meeting these requirements requires different numerologies, this being incompatible with use of the same bandwidth part.

Alternatively, as illustrated by FIGS. 3 and 4, it is known to send DCI comprising a different indicator of bandwidth part, BWP1, BWP2, before each transmission associated with a different service, Serv1, Serv2, to cause the user equipment to switch active band between transmissions associated with different services. FIGS. 3 and 4 illustrate the switch between active bands, BWP1, BWP2, in the downlink direction, DL DCI, and in the uplink direction, UL DCI, respectively.

This method is time-consuming since the user equipment must wait for DCI, i.e. a number of slots (several milliseconds), before being able to switch active band and receive thereafter its data, as illustrated in FIG. 5. In this illustration, the user equipment UE receives data in slice 1 in the bandwidth part BWP1. It must wait a time Δt1 to receive new DCI with the indication of a new bandwidth part BWP2 before being able to switch from active bandwidth part, from BWP1 to BWP2, and receive data associated with slice 2 on the radio resources PRBs Slice2. Before the switch, the user equipment cannot receive data of this slice 2 on the radio resources PRBs Slice2 associated with it. Likewise, to switch back to the bandwidth part BWP1, the UE must wait a time Δt2 to receive new DCI with the indication of the bandwidth part BWP1 before being able to switch active bandwidth part, from BWP2 to BWP1, and receive data associated with the slice (slice 12) on the radio resources PRBs Slice1. Before the switch, the user equipment cannot receive data of this slice 1 on the radio resources PRBs Slice1 associated with it. The base station (BS) determines the schedule of the user equipment by sending DCI at Δt1 and Δt2, in an attempt to ensure the performance (KPI) required for each slice is achieved. Such a mechanism is incompatible with a URLLC service, which tolerates a latency of at most one millisecond.

### Main Features of the Invention

One subject of the present invention is a communication method comprising:
transmission in a first transmission interval of control information comprising a first indicator of a bandwidth part for transmitting data associated with a first slice via the first bandwidth part,
   such that:
the control information transmitted in the first transmission interval further comprises a second indicator of a bandwidth part for transmitting or receiving, via this second bandwidth part, data associated with a second slice, and a first switching time indicator for switching active bandwidth part between the first bandwidth part and the second bandwidth part.

Another subject of the invention is a communication method comprising:
reception in a first transmission interval of control information comprising a first indicator of a bandwidth part for receiving data associated with a first slice via the first bandwidth part,
   such that:
the control information received in the first transmission interval further comprises a second indicator of a bandwidth part for receiving or transmitting, via this second bandwidth part, data associated with a second slice, and a first switching time indicator for switching active bandwidth part between the first bandwidth part and the second bandwidth part.

A further subject of the invention is a telecommunication device comprising at least one transmitter and one receiver, the device being configured to:
receive, in a first transmission interval, control information comprising a first indicator of a bandwidth part, a second indicator of a bandwidth part and a first switching time indicator for switching active bandwidth part between the first bandwidth part and the second bandwidth part,
receive or transmit data associated with a first slice via the first bandwidth part and, after switching active bandwidth part, data associated with a second slice via the second bandwidth part.

A further subject of the invention is a telecommunication device comprising at least one transmitter and one receiver, the device being configured to:
transmit, in a first transmission interval, control information comprising a first indicator of a bandwidth part, a second indicator of a bandwidth part and a first switching time indicator for switching active bandwidth part between the first bandwidth part and the second bandwidth part,
transmit data associated with a first slice via the first bandwidth part and, after switching active bandwidth part, data associated with a second slice via the second bandwidth part.

A further subject of the invention is a telecommunication system comprising a base station and a user equipment, for implementing a communication method according to the invention. The transmission of control information allows scheduling to be achieved in one or more UEs. The entity responsible for this transmission may be a base station, a base-station controller or a specific entity called the scheduler. The UE or UEs to be scheduled are connected to a core network via an access network to which the scheduler belongs. The UE or UEs are connected to various services or slices corresponding to QoS flows. The scheduler determines, for a given user equipment, the values of the switching time indicators J1, J2, . . . , depending in particular on the qualities associated with the QoS flows and on the radio performance of the transmission channel between the access network and this user equipment, in order to ensure a switching delay between active bands that is compatible with the latency requirements of the services to which the user equipment is connected. By simultaneously transmitting two indicators of bandwidth parts, only one of which is active in a given transmission interval, and an indicator of the time of the transmission interval in which active bandwidth part must be switched, the method can decrease latency time with respect to a mechanism that needs to wait for a new transmission of control information to trigger switching of active bandwidth part.

According to one embodiment, the method further comprises:
before the transmission of the control information, reception of an identifier of the first slice and of an identifier of the second slice to associate a given user equipment with these first and second slices.

According to one embodiment, the control information transmitted in the first transmission interval further comprises a first indicator of a time offset after the first transmission interval for transmitting data associated with the first slice via the first bandwidth part and the active bandwidth part is switched after scheduling of the data associated with the first slice and transmitted via the first bandwidth part.

In some embodiments, said first switching time indicator is a time index of a first transmission slot and said second switching time indicator is a time index of a second transmission slot.

According to one embodiment, the method further comprises:
before the reception of the control information, transmission of an identifier of the first slice and of an identifier of the second slice to associate a given user equipment with the first and second slices.

According to one embodiment, the first bandwidth part and the second bandwidth part each have different respective numerologies.

According to one embodiment, the control information is carried by the same control channel.

According to one embodiment, the data associated with the first slice and the data associated with the second slice are received or transmitted in the same shared channel for received data or the same shared channel for transmitted data.

According to one embodiment, the data associated with the first slice and the data associated with the second slice are associated with services of different types.

According to one embodiment, the data associated with one of the slices are associated with a URLLC service, URLLC being the abbreviation of Ultra Reliable and Low Latency Communication.

Features that are presented separately in the present application, in connection with certain embodiments of the method of the present application, may be combined together into other embodiments of the present method.

The optional features presented above in the context of the communication method may possibly apply to the devices, to the software application and to the memory medium of the software application according to the invention.

### LIST OF THE FIGURES

Other features and advantages of the invention will become more clearly apparent on reading the following description of embodiments, which are given by way of simple illustrative and non-limiting examples, and the appended drawings, in which:

FIG. 1 is a diagram illustrating scheduling in a user equipment for received DCI of format 1_1, which was described with regard to the prior art,

FIG. 2 is a diagram illustrating scheduling in a user equipment for received DCI of format 0_1, which was described with regard to the prior art,

FIG. 3 is a scheduling diagram illustrating a user equipment switching between active bands in the downlink direction, DL DCI, which was described with regard to the prior art,

FIG. 4 is a scheduling diagram illustrating a user equipment switching between active bands in the uplink direction, UL DCI, which was described with regard to the prior art,

FIG. 5 is a diagram illustrating implementation of one example of scheduling according to the prior art in a user equipment connected via a base station to two services,

FIG. 6 is a diagram of a telecommunication network,

FIG. 7 is a protocol exchange diagram,

FIG. 8 is a diagram of a time-frequency grid corresponding to a time and frequency division of the radio resources of the transmission channel,

FIG. 9 is a diagram illustrating an implementation by a configured user equipment of an embodiment of a method according to the invention,

FIG. 10 is a diagram illustrating implementation of one example of scheduling according to the invention in a user equipment connected via a base station to two services,

FIG. 11 is a diagram of one embodiment of a base station according to the invention,

FIG. 12 is a diagram of one embodiment of a terminal according to the invention,

FIG. 13 is a diagram of a telecommunication network in an O-RAN context.

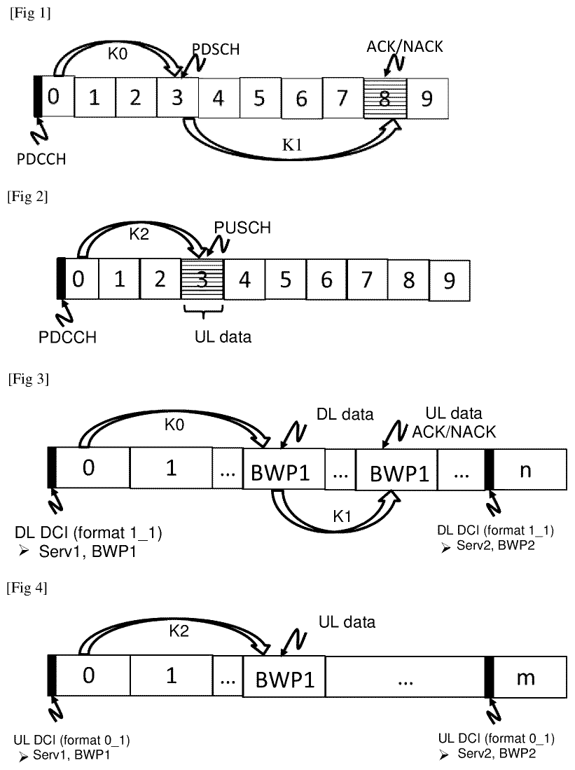

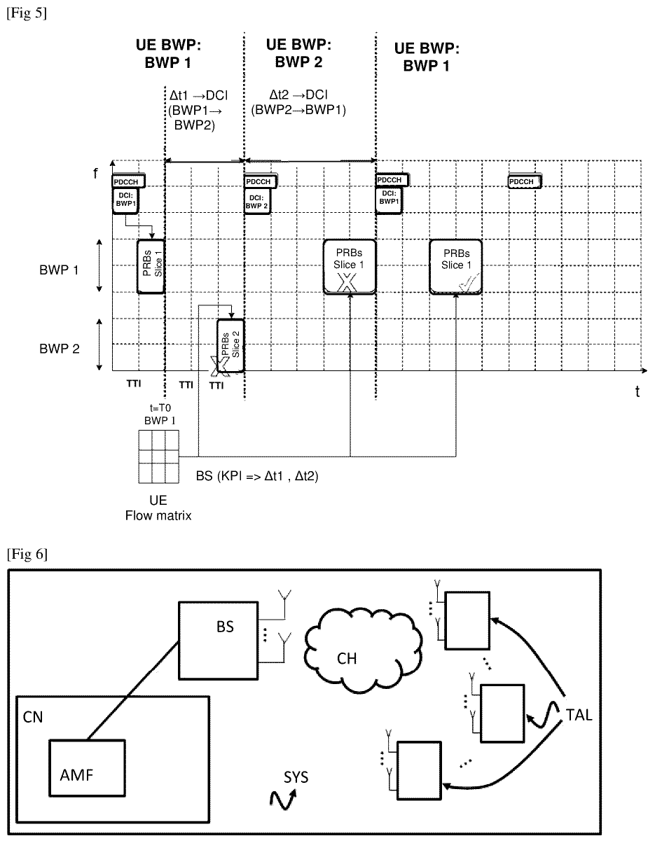

### DESCRIPTION OF PARTICULAR EMBODIMENTS

The invention is applicable in the context of a telecommunication network (illustrated in FIG. 6) with a service-oriented architecture, as 5G networks have. Thus, the network is divided into slices that are separated from and independent of one another from the point of view of the user equipment: each slice is a logical entity associated with a service (for example URLLC, eMBB, etc.). A slice is identified by its S-NSSAI identifier.

The telecommunication network SYS comprises a core network CN and an access network with at least one base station BS (called gNB in 5G networks). The base station may be realized with a single piece of hardware or be distributed over several pieces of hardware. The core network comprises a central logical entity called the AMF (Access and Mobility Function). Among other things, the AMF is responsible for the control signaling between the network core and the user equipment TAL. Functionalities between the AMF and a user equipment TAL are sometimes referred to as NAS (Non-Access Stratum) as opposed to functionalities referred to as AS (Access Stratum) between the access network and a user equipment.

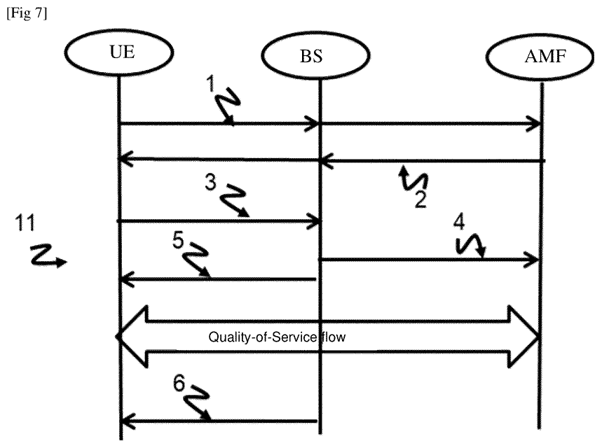

FIG. 7 schematically illustrates certain protocol exchanges for implementation of a method 11 according to the invention.

Once it has detected a cell that is associated with a base station, the user equipment (abbreviated UE below) camps on this cell and then accesses the cell using a so-called RACH protocol. Non-limitingly, the cell and the base station are considered to be one and the same.

During an initial attachment procedure, the UE makes a registration request 1 (RRC setup) by providing a list of S-NSSAI identifiers of the services it wishes to request (“requested NSSAI”). The AMF completes 2 the registration by supplying the UE, in a message (“allowed NSSAI”), with the list of S-NSSAI identifiers of the services, i.e. of the slices, that it is allowed to request. According to the 5G specifications, the number of identifiers allowed by a UE is limited to eight. The base station is informed 2 of the list of S-NSSAI identifiers allowed by the UE.

A similar mechanism is employed during a so-called “RRC reconfiguration” request, during which the list of S-NSSAI identifiers allowed by the UE is updated.

The specifications of a 5G network define several states in which a UE may be: RRC_idle, RRC_inactive and RRC_connected. In the RRC_connected state (more commonly referred to as the connected state) a connection has been set up between the UE and the core network, and data exchange is possible between the base station and the UE.

A UE is connected using a protocol that may be based on functionalities of the NAS control plane, between the UE and the AMF, and on functionalities of the RRC (Radio Resource Control) control plane. The set-up of a connection comprises setting up at least one PDU data session with an S-NSSAI identifier selected by the UE and transmitted 3 to the base station. Linked 4 with the AMF, the base station returns 5 to the UE the accepted S-NSSAI identifier. For a connected UE, there are one or more PDU sessions, each with one or more QoS flows and radio data bearers. IP packets are mapped by the core network to the QoS flows according to QoS requirements. Furthermore, the QoS flows are mapped onto the radio data bearers by the access network. The UE can observe the QFIs (QoS Flow Identifiers) associated with the packets received in downlink flows to determine which IP flow is mapped onto which QoS flow and onto which radio data bearer and to use a similar mapping for the uplink. When the base station informs the UE of the acceptance of the request to set up a PDU session, it returns a message to the UE that contains the accepted slice S-NSSAI identifier and information such as the QFI, the flow QoS required, 5QI (5G Quality Indicator)—which takes into account the maximum permissible delay, the priority for the flow, and the type of service (video, voice, etc.). A PDU session may contain multiple QoS flows. Each QoS flow may transport a number of SDFs (Service Data Flows), known as traffic flows, provided they meet the same requirements. A slice may transport multiple QoS flows, but a QoS flow can be transported only by a single slice.

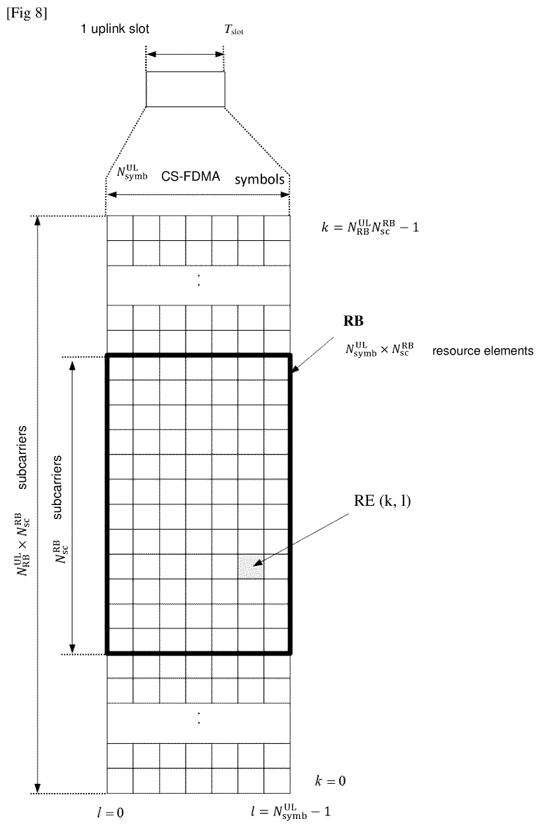

Transmission between the base station of the access network and the UE occurs in a channel that is shared between the various UEs connected to the core network. Stated otherwise, the time-frequency resources of the transmission channel are dynamically shared between the users, either in a TDD (Time Division Duplex) mode or in an FDD (Frequency Division Duplex) mode. Transmissions are scheduled both in the uplink direction and in the downlink direction, and reflect scheduling decisions orchestrated at a temporal rate, typically per slot, one slot lasting one TTI (Transmission Time Interval) according to the technical specifications of 5G networks. When the access network implements a multi-carrier modulation such as OFDM, the radio resources of the transmission channel are schematically represented by a time-frequency grid, as illustrated in FIG. 8. Each element of the grid is called an RE (Resource Element) and is identified by a time index l and a frequency index k. A multicarrier symbol is identified by a time index l.

The scheduling of a UE consists in assigning it resource elements of this grid, generally one or more PRBs (Physical Resource Blocks) of resource elements identified for example by a number of contiguous resource blocks, a start time interval and a first subcarrier when the blocks are contiguous.

Given that the frequency spectrum is very wide, the specifications of 5G networks introduced the notion of BWP (Bandwidth Part). A BWP is a set of contiguous PRBs (Physical Resource Blocks) associated with one numerology.

Thus, UE scheduling is accompanied by an indication of the active bandwidth part, which specifies the frequency area where the resource elements allocated to the UE are located, and therefore the frequency area that the UE must scan in the downlink direction for reception purposes and that the UE uses in the uplink direction to transmit. There may be two different active band indications, one for the downlink channel and one for the uplink channel.

The scheduling information is transmitted 6 by the base station to the UE via a control channel. According to the specifications of 5G networks, this control information is included in the DCI and transported by the PDCCH channel.

The scheduling may take into account information (CSI Channel State Information, CQI Channel Quality Indicator) on the quality of the channel between the base station and the UE when deciding how many resource elements allocate to a scheduled UE.

According to the invention, the scheduling takes into account the slicing of the network and more particularly the fact that the UE can simultaneously request a plurality of services associated with different slices, for example a URLLC service and an eMBB service, and potentially having very different requirements in terms of latency and/or data rate. The set of NSSAIs designates the identifiers of the slices requested by a terminal.

Thus, during transmission in a first transmission interval of control information, the latter comprises a first indicator of a bandwidth part BWP1 for transmitting data associated with a first slice via this active first bandwidth part BWP1. Furthermore, according to the invention, the control information transmitted in the first transmission interval further comprises at least:
a second indicator of a bandwidth part BWP2 for transmitting, i.e., for transmitting or receiving, via this second bandwidth part BWP2, data associated with a second slice, and
a first switching time indicator J1 for switching active bandwidth part between the first bandwidth part BWP1 and the second bandwidth part BWP2.

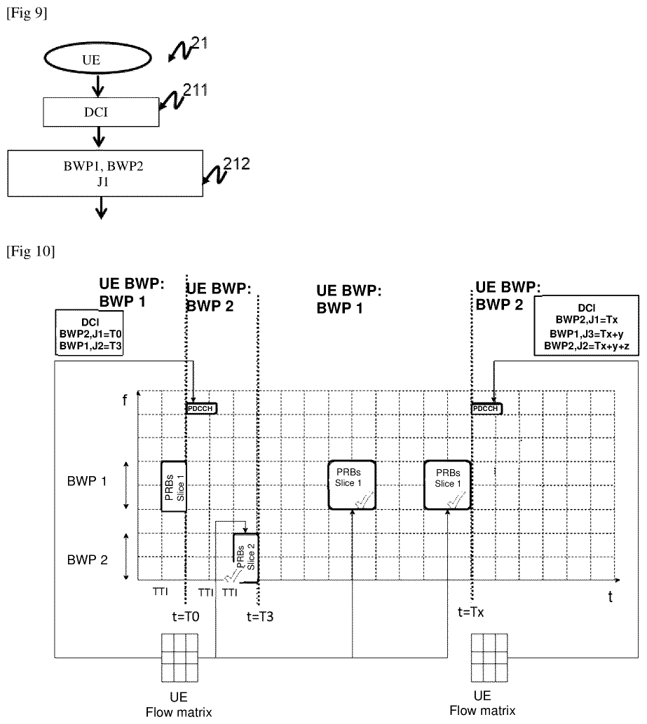

An implementation by a configured UE of an embodiment of a method according to the invention is schematically illustrated in FIG. 9. The UE is configured in that it implements the reception method 21 according to the invention, according to which control information, received 211 in a first transmission interval via a dedicated control channel, comprises 212:
a first indicator of a bandwidth part BWP1 for transmitting data associated with a first slice via this active first bandwidth part BWP1 and furthermore at least:
a second indicator of a bandwidth part BWP2 for transmitting, i.e., for transmitting or receiving, via this second bandwidth part BWP2, data associated with a second slice, and
a first switching time indicator J1 for switching active bandwidth part between the first bandwidth part BWP1 and the second bandwidth part BWP2.

Non-limitingly, the value of the switching time indicator J1 may be determined in number of transmission intervals (slots) from the transmission interval (slot) of reception of the control information. This value may equally well be determined relative to another event, for example reception of data or transmission of data.

Of course, the control information transmitted in the first transmission interval may comprise more than two indicators of bandwidth parts and/or more than one switching time indicator, with a view to successively switching active bandwidth part without waiting for a new transmission of control information, each bandwidth part being associated with one slice of S-NSSAI identifier.

According to one embodiment, the control information transmitted in the first transmission interval may further comprise a second switching time indicator J2 for switching active bandwidth part between the second bandwidth part BWP2 and the first bandwidth part BWP1, with J2>J1.

The base station can determine the number of indicators of bandwidth parts and switching time indicators to be transmitted in a given transmission interval based on various parameters selected from at least: the number of services (slices) to which the UE is connected, the number of QoS flows and the associated 5QIs, and the type of traffic flow. The base station may further rely on performance indicators such as indications (CSI, CQI, etc.) of the quality of the radio link between the UE and the base station. The base station may further request from the UE feedback on indicators of the received signal level, of the MCS (Modulation and Coding Scheme) it requires, of a SNR (Signal-to-Noise Ratio), and/or of a SINR (Signal-to-Interference-plus-Noise Ratio).

Using these various pieces of information, parameters and indicators, the base station may optionally make traffic predictions per slice to determine the control information to be communicated to the UE in a dedicated control channel.

The base station may determine the values of the switching time indicators J1, J2, . . . , depending in particular on the 5QIs associated with the QoS flows and on radio performance, in order to ensure a switching delay between active bands that is compatible with the latency requirements of the services to which the UE is connected.

To determine the control information to be transmitted, the base station may establish a flow matrix for the QoS flows of the UE.

The control information transmitted in the first transmission interval may further comprise a first indicator K0 of a time offset after the first transmission interval to wait for reception of data on the first bandwidth part BWP1.

The control information transmitted in the first transmission interval may further comprise a second indicator K1 of a time offset giving the offset in number of slots between when radio resources are scheduled for the downlink (PDSCH) and when the ACK/NACK is to be transmitted by the same UE.

The switch according to J1 of the active bandwidth part may then take place after scheduling of the data associated with the first slice, which data are transmitted via the first bandwidth part BWP1.

In the case of scheduling a UE for an uplink transmission, the control information transmitted in the first transmission interval may further comprise a first indicator K2 of a time offset after the first transmission interval for transmitting uplinked data, via the first bandwidth part BWP1. K2 gives the offset in number of slots between the reception of the DCI, and the radio resources scheduled for the PUSCH uplink.

FIG. 10 schematically illustrates one implementation of one example of scheduling, according to the invention, of a UE connected via a base station with two services including an eMBB 1^{st} service (slice) associated with a first bandwidth part BWP1 and a URLLC 2^{nd} service (slice) associated with a second bandwidth part BWP2. To ensure the URLLC 2^{nd} service obtains a low latency, it has a higher priority than the eMBB 1^{st} service and employs a bandwidth part BWP2 different from the bandwidth part BWP1 allocated to the eMBB 1^{st} service.

In this example shown, the base station maintains an up-to-date matrix of flows and associated parameters that they collect. At the time t=T0, the base station transmits, via a control channel (PDCCH) dedicated to the UE, DCI that is based on this matrix and that contains a first indicator of a bandwidth part BWP2 and a switching time indicator/1=TO indicating to switch active bandwidth part immediately, i.e. during the current slot of time index t=T0. The UE that receives the dedicated control channel and that had the bandwidth part BWP1 active before T0, switches at T0 to the bandwidth part BWP2, which becomes the active part. The DCI transmitted in T0 may further comprise a second indicator of a bandwidth part BWP1 and a switching time indicator J2=T3 indicating to switch active bandwidth part in the slot of time index t=T3. After switching active band from BWP1 to BWP2, the UE receives data of the 2nd service on radio resources, PRB Slice 2, forming part of the active bandwidth part BWP2. After switching the active band from BWP2 to BWP1, the UE receives, at two different times, data of the 1^{st} service on radio resources, PRB Slice 1, forming part of the active bandwidth part BWP1.

At the time t=Tx, the base station transmits, via the dedicated control channel (PDCCH), DCI that is based on the matrix and that contains a first indicator of a bandwidth part BWP2 and a first switching time indicator J1 indicating to switch active bandwidth part immediately, i.e. during the current slot of time index t=Tx, and a second switching time indicator J2 indicating to switch active bandwidth part in the slot of time index t=Tx+y=z. The UE, which had the bandwidth part BWP1 active before Tx, switches at Tx its active bandwidth part to BWP2. The DCI transmitted at Tx further comprises a second indicator of a bandwidth part BWP1 and a switching time indicator 3=Tx+y indicating to switch active bandwidth part in the slot of time index t=Tx+y.

Of course, the UE may have n≥2 services active and the DCI may contain more than two indicators of bandwidth part BWP2 and more than one switching time indicator.

The method is able to make it possible to switch active bandwidth part more efficiently through transmission, in advance via the same dedicated control channel, for example PDCCH/DCI, of one or more switching time indicators for switching active bandwidth part, instead of waiting for a new dedicated control channel, for example PDCCH/DCI. The method can therefore contribute to a reduction in latency and may therefore make it possible to ensure the quality expected for a URLLC service.

This method has the advantage of being UE-compatible since it does not require the UE to simultaneously activate two bandwidth parts of different numerologies. Specifically, the one and only bandwidth part active at a given time according to the method is associated with a single numerology and therefore compatible with the multicarrier processing specified in the technical specifications of the 5G system of the 3GPP, until at least release 17.

An implementation of the method compliant with the technical specifications of a 5G network merely requires addition of a few fields to the dedicated control channel, PDCCH/DCI, but does not require any modification to the size of the DCI since the latter contains fields of variable size the size of which may be adjusted.

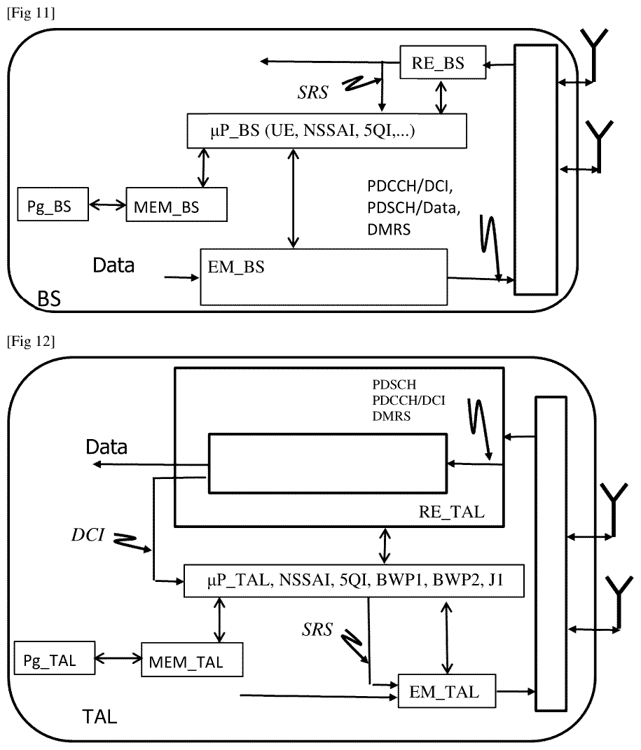

As regards the base station, the implementation detailed above is non-limiting in respect of the number of UEs connected via this base station and taken into account by the method. The latter may be implemented with a plurality of UEs and, for each UE, the base station determines the dedicated control channel, PDCCH/DCI, to be transmitted in the same way as for a single UE. FIG. 11 is a diagram of the simplified structure of one embodiment of a base station BS according to one embodiment of the invention.

The base station BS comprises at least a microprocessor μP_BS, the operation of which is controlled by the execution of a program the instructions of which make it possible to implement a method according to the invention, a memory MEM_BS, a transmitter EM_BS and a receiver RE_BS which are connected to one another by means of a bus for example. Of course, the constituent elements of the base station BS may be connected by means of a connection other than a bus.

The microprocessor μP_BS controls the operations of the base station BS. The storage unit MEM_BS stores at least the program for implementing the method according to one embodiment of the invention to be executed by the processor μP_BS, and various data, such as parameters and/or indictors (NSSAI, 5QI) associated with a user equipment, UE, which parameters and/or indicators are used for computations performed by the microprocessor μP, intermediate data of computations performed by the microprocessor μP, etc. The microprocessor μP_BS may be formed by any known and appropriate hardware or software, or by a combination of hardware and software. For example, the microprocessor μP_BS may be formed by dedicated hardware, such as a processing circuit, or by a programmable processing unit such as a central processing unit which executes a program stored in a memory thereof. The memory MEM_BS may be formed by any appropriate means capable of storing the program or programs and data in a manner readable by a microprocessor. Examples of a memory MEM_BS comprise non-transitory storage media such as: semiconductor memory devices; and magnetic, optical, or magneto-optical storage media loaded into a read-write unit controlled by the microprocessor.

Upon initialization, the code instructions of the program are, for example, loaded into a buffer memory before being executed by the microprocessor μP_BS. The microprocessor μP_BS controls the various components of the base station BS.

Thus, by executing the instructions, the microprocessor μP_BS makes it possible for the base station BS to implement the method according to one embodiment of the invention, which comprises:
transmission, implemented by the transmitter EM_BS, in a first transmission interval, TTI, of control information, DCI, comprising a first indicator of a bandwidth part, BWP1, for transmitting data associated with a first slice via the first bandwidth part, BWP1,
   such that:
the control information, DCI, transmitted in the first transmission interval, TTI, further comprises a second indicator of a bandwidth part, BWP2, for transmitting by means of the transmitter EM_BS or receiving by means of the receiver BS_RE, via this second bandwidth part, BWP2, data associated with a second slice, and a first switching time indicator, J1, for switching active bandwidth part between the first bandwidth part, BWP1, and the second bandwidth part, BWP2.

The transmitter EM_BS may transmit pilot signals, for example DMRSs, in order to allow the UE to determine the quality of the downlink channel. The receiver RE_BS may receive pilot signals, for example SRSs, from a UE with a view to determining the quality of the uplink channel and, by reciprocity, deducing therefrom a quality of the downlink channel. Other techniques well known to those skilled in the art may be used for the purposes of channel estimation, irrespectively of whether the channel in question is the uplink or downlink.

FIG. 12 is a diagram of the simplified structure of one embodiment of a user equipment TAL, according to one embodiment of the invention.

The user equipment TAL comprises at least a microprocessor μP_TAL, the operation of which is controlled by the execution of a program the instructions of which make it possible to implement a communication method according to the invention, a memory MEM_TAL, a transmitter EM_TAL and a receiver RE_TAL which are connected to one another by means of a bus for example. Of course, the constituent elements of the user equipment TAL may be connected by means of a connection other than a bus.

The microprocessor μP_TAL controls the operations of the user equipment TAL. The storage unit MEM_TAL stores at least the program for implementing the method according to one embodiment of the invention to be executed by the processor μP_TAL, and various data, such as parameters and/or indictors (NSSAI, 5QI) used for computations performed by the microprocessor μP_TAL, intermediate data of computations performed by the microprocessor μP_TAL, etc. The microprocessor μP_TAL may be formed by any known and appropriate hardware or software, or by a combination of hardware and software. For example, the microprocessor μP_TAL may be formed by dedicated hardware, such as a processing circuit, or by a programmable processing unit such as a central processing unit which executes a program stored in a memory thereof.

The memory MEM_TAL can be formed by any appropriate means which is capable of storing the program or the programs and data in a computer-readable manner. Examples of a memory MEM_TAL comprise non-transitory storage media such as: semiconductor memory devices; and magnetic, optical, or magneto-optical storage media loaded into a read-write unit controlled by the microprocessor.

Upon initialization, the code instructions of the program are, for example, loaded into a buffer memory before being executed by the microprocessor μP_TAL. The microprocessor μP_TAL controls the various components of the user equipment TAL.

Thus, by executing the instructions, the microprocessor μP_TAL makes it possible for the user equipment TAL to implement the communication method, which according to one embodiment of the invention comprises:
reception, by the receiver RE_TAL, in a first transmission interval, TTI, of control information, DCI, comprising a first indicator of a bandwidth part, BWP1, for receiving data associated with a first slice via the first bandwidth part, BWP1,
   such that:
the control information, DCI, received in the first transmission interval, TTI, further comprise a second indicator of a bandwidth part, BWP2, for receiving by means of the receiver RE_TAL or transmitting by means of the transmitter EM_TAL, via this second bandwidth part, BWP2, data associated with a second slice, and a first switching time indicator, J1, for switching active bandwidth part between the first bandwidth part, BWP1, and the second bandwidth part, BWP2.

The transmitter EM_TAL may transmit pilot signals, for example SRSs, in order to allow the base station to determine the quality of the uplink channel. The receiver RE_TAL may receive pilot signals, for example DMRSs, from a base station with a view to determining the quality of the downlink channel and, by reciprocity, deducing therefrom a quality of the uplink channel. The user equipment may then feed back to the base station an estimate of the quality of the downlink channel. Other techniques well known to those skilled in the art may be used for the purposes of channel estimation, irrespectively of whether the channel in question is the uplink or downlink.

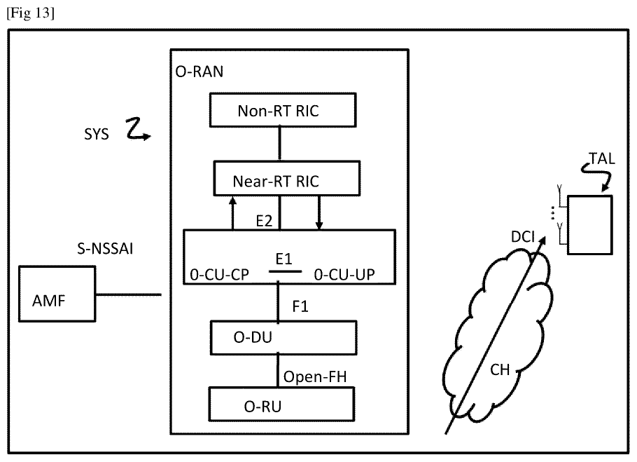

In the context of a telecommunication network with an access network of the O-RAN type, as illustrated by FIG. 13, the communication method in its base-station version may be implemented by an entity referred to as a RIC (RAN Intelligent Controller) or near-RT RIC (near-RealTime RIC).

In this O-RAN context the base station is disaggregated into several entities: non-RT RIC, near-RT RIC, O-CU-CP, O-CU-UP, O-DU and O-RU. Interfaces are defined between these various entities: A1 between the entities non-RT RIC and near-RT RIC, E2 between the entities near-RT RIC and O-CU-CP/O-CU-UP, E1 between O-CU-CP and O-CU-UP, F1 between the entities O-CU-CP/O-CU-UP and O-DU, and Open FH between the entities O-DU and O-RU. Each entity is responsible for specific functions and one protocol layer. In particular, the entity O-RU is responsible for the low physical layer, and the entity O-DU is responsible for the high physical layer and layer 2 with the MAC protocol and scheduling. The RICs are controllers that run algorithms. Algorithms with a timescale of 10 ms to 1 second are run in the “near-RT RIC” while algorithms with a timescale greater than 1 second are run in the “non-RT RIC”. Since the determination of the DCI must be compatible with a very constraining latency time, the DCI is determined in the “near-RT RIC”. This entity receives as input data measurements from the user equipment TAL, NSSAI slice indicators provided by the AMF, parameters, and 5QI quality indicators, which allow it to construct a flow matrix. The matrix then makes it possible to determine the DCI and the format in which it is to be transmitted to the UE.

1. A communication method implemented by a communication device and comprising:
transmitting in a first transmission interval control information comprising:
a first indicator of a first bandwidth part for transmitting data associated with a first slice via the first bandwidth part,
a second indicator of a second bandwidth part for transmitting or receiving, via this second bandwidth part, data associated with a second slice, and
a first switching time indicator for switching an active bandwidth part between the first bandwidth part and the second bandwidth part.

2. The method as claimed in claim 1, wherein said first switching time indicator is a time index of a first transmission slot.

3. The method as claimed in claim 1, further comprising:
before the transmitting of the control information, receiving an identifier of the first slice and of an identifier of the second slice to associate a given user equipment with the first and second slices.

4. The method as claimed in claim 1, wherein the control information transmitted in the first transmission interval further comprises a first indicator of a time offset after the first transmission interval for transmitting data associated with the first slice via the first bandwidth part and wherein the active bandwidth part is switched after scheduling of the data associated with the first slice and transmitted via the first bandwidth part.

5. A communication method implemented by a communication device and comprising:
receiving in a first transmission interval of control information comprising:
a first indicator of a bandwidth part for receiving data associated with a first slice via the first bandwidth part,
a second indicator of a bandwidth part for receiving or transmitting, via this second bandwidth part, data associated with a second slice, and
a first switching time indicator for switching active bandwidth part between the first bandwidth part and the second bandwidth part.

6. The method as claimed in claim 5, wherein said first switching time indicator is a time index of a first transmission slot and said second switching time indicator is a time index of a second transmission slot.

7. The method as claimed in claim 5, further comprising:
before receiving the control information, transmitting an identifier of the first slice and an identifier of the second slice to associate a given user equipment with the first and second slices.

8. The method as claimed in claim 5, wherein the first bandwidth part and the second bandwidth part each have different respective numerologies.

9. The method as claimed in claim 5, wherein the control information is carried by a same control channel.

10. The method as claimed in claim 5, wherein the data associated with the first slice and the data associated with the second slice are received or transmitted in a same shared channel for received data or a same shared channel for transmitted data.

11. The method as claimed in claim 5, wherein the data associated with the first slice and the data associated with the second slice are associated with services of different types.

12. The method as claimed in claim 5, wherein the data associated with one of the slices are associated with an Ultra Reliable and Low Latency Communication (URLLC) service.

13. A telecommunication device comprising:
at least one transmitter and at least one receiver; and
at least one processor configured to:
receive using the at least one receiver, in a first transmission interval, control information comprising a first indicator of a first bandwidth part, a second indicator of a second bandwidth part and a first switching time indicator for switching an active bandwidth part between the first bandwidth part and the second bandwidth part,
receive using the at least one receiver or transmit using the at least one transmitter data associated with a first slice via the first bandwidth part and, after switching the active bandwidth part, data associated with a second slice via the second bandwidth part.

14. A telecommunication device comprising:
at least one transmitter and at least one receiver; and
at least one processor configured to:
transmit using the at least one transmitter, in a first transmission interval, control information comprising a first indicator of a first bandwidth part, a second indicator of a second bandwidth part and a first switching time indicator for switching an active bandwidth part between the first bandwidth part and the second bandwidth part,
transmit using the at least one transmitter data associated with a first slice via the first bandwidth part and, after switching the active bandwidth part, data associated with a second slice via the second bandwidth part.

15. A non-transitory computer readable medium comprising a computer program stored thereon comprising instructions for executing the method as claimed in claim 1 when said program is executed by a computer of the communication device.

16. The method as claimed in claim 1, wherein the first bandwidth part and the second bandwidth part each have different respective numerologies.

17. The method as claimed in claim 1, wherein the control information is carried by a same control channel.

18. The method as claimed in claim 1, wherein the data associated with the first slice and the data associated with the second slice are received or transmitted in a same shared channel for received data or a same shared channel for transmitted data.

19. The method as claimed in claim 1, wherein the data associated with the first slice and the data associated with the second slice are associated with services of different types.

20. The method as claimed in claim 1, wherein the data associated with one of the slices are associated with an Ultra Reliable and Low Latency Communication (URLLC) service.
